(19) United States
(12) Patent Application Publication
(10) Pub. No.: US 2025/0155876 A1
(43) Pub. Date: May 15, 2025

(54) COMPUTER SYSTEM AND METHOD OF PLANNING COUNTERMEASURE

(71) Applicant: Hitachi, Ltd., Tokyo (JP)

(72) Inventors: Yoshiki YUMBE, Tokyo (JP); Yu IKEMOTO, Tokyo (JP); Mami TAKAHASHI, Tokyo (JP)

(73) Assignee: Hitachi, Ltd., Tokyo (JP)

(21) Appl. No.: 18/836,540

(22) PCT Filed: Sep. 7, 2022
(86) PCT No.: PCT/JP2022/033571

§ 371 Date: Aug. 7, 2024

(30) Foreign Application Priority Data
Mar. 14, 2022 (JP) 2022-038888

(51) Int. Cl. G05B 19/418

(52) U.S. Cl. CPC G05B 19/4184

(57) ABSTRACT

A computer system that plans a countermeasure relating to disaster recovery in a facility stores cost information for managing a first cost that is an amount of opportunity loss during occurrence of a disaster per facility for which a countermeasure is to be executed and a second cost required for a countermeasure of self-investment, and provision resource information for managing a resource that is externally provided. The computer system refers to the provision resource information to determine whether the resource required for executing a countermeasure utilizing the resource in the designated facility can be ensured, and selects a countermeasure to be executed on the designated facility based on the first cost, the second cost, and a result of the determination.

### INCORPORATION BY REFERENCE

The present application claims priority based on Japanese Patent Application No. 2022-38888 filed Mar. 14, 2022, the content of which is incorporated herein by reference.

### TECHNICAL FIELD

The present invention relates to a system and a method for planning a countermeasure relating to disaster recovery.

### BACKGROUND ART

As a background art in this technical field, there is disclosed in PTL 1. PTL 1 discloses a resource allocation support device and a resource allocation support method for implementing optimum resource distribution in consideration of a difference in provision form between resources.

### CITATION LIST

### Patent Literature

PTL 1: JP2021-117780A

### SUMMARY OF INVENTION

### Technical Problem

In the method disclosed in PTL 1, when a disaster occurs, resources used for disaster recovery are allocated between a plurality of business operators to effectively execute the disaster recovery. However, there is a case that cannot be handled by allocating resources. For example, when the blackout risk caused by occurrence of a disaster is high such that provision of resources used for power supply cannot be expected, resources are insufficient during the occurrence of the disaster, and the possibility of opportunity loss increases. Therefore, a business operator needs to consider a countermeasure other than the resource allocation.

As described above, there is a problem in that it is difficult to determine a countermeasure in consideration of a cost required for the countermeasure and a provision situation of resources.

The present invention has been made in consideration of the above-described problems, and an object thereof is to provide a system and a method for planning a countermeasure in consideration of a cost required for the countermeasure and a provision situation of resources.

### Solution to Problem

A representative example of the present invention disclosed in the present application is as follows. That is, provided is a computer system that plans a countermeasure relating to disaster recovery in a facility, the computer system including: at least one computer that includes a processor, a storage device connected to the processor, and a network interface connected to the processor, in which the storage device stores cost information for managing a first cost that is an amount of opportunity loss during occurrence of a disaster per facility for which a countermeasure is to be executed and a second cost required for a countermeasure of self-investment, and provision resource information for managing a resource that is externally provided, and the processor refers to the provision resource information to determine whether the resource required for executing a countermeasure utilizing the resource in the designated facility can be ensured, and selects a countermeasure to be executed on the designated facility based on the first cost, the second cost, and a result of the determination.

### Advantageous Effects of Invention

With one representative configuration of the present invention, a countermeasure can be planned in consideration of a cost required for the countermeasure and a provision situation of resources. Objects, configurations, and effects other than those described above will be clarified by describing the following embodiment.

### BRIEF DESCRIPTION OF DRAWINGS

FIG. 1 is a block diagram illustrating an example of a configuration of a disaster countermeasure planning system according to a first embodiment.

FIG. 2A is a diagram illustrating an example of a data structure of a business operator DB in the first embodiment.

FIG. 2B is a diagram illustrating the example of the data structure of the business operator DB in the first embodiment.

FIG. 3 is a diagram illustrating an example of a data structure of a disaster risk DB in the first embodiment.

FIG. 4 is a diagram illustrating an example of a data structure of a power DB in the first embodiment.

FIG. 5A is a diagram illustrating an example of a data structure of a facility DB in the first embodiment.

FIG. 5B is a diagram illustrating the example of the data structure of the facility DB in the first embodiment.

FIG. 6 is a diagram illustrating an example of a data structure of a provision resource DB in the first embodiment.

FIG. 7 is a diagram illustrating an example of a data structure of a matching result DB in the first embodiment.

FIG. 8 is a diagram illustrating an example of a data structure of a dispatch plan DB in the first embodiment.

FIG. 9A is a diagram illustrating an example of a data structure of a countermeasure history DB in the first embodiment.

FIG. 9B is a diagram illustrating an example of the data structure of the countermeasure history DB in the first embodiment.

FIG. 10 is a diagram illustrating an example of a data structure of a settlement DB in the first embodiment.

FIG. 11A is a diagram illustrating an example of a usage flow of the countermeasure planning system according to the first embodiment.

FIG. 11B is a diagram illustrating an example of a usage flow of the countermeasure planning system according to the first embodiment.

FIG. 12 is a diagram illustrating an example of a screen displayed by a terminal according to the first embodiment.

FIG. 13 is a diagram illustrating an example of a screen displayed by the terminal according to the first embodiment.

FIG. 14 is a diagram illustrating an example of a screen displayed by the terminal according to the first embodiment.

FIG. 15 is a diagram illustrating an example of a screen displayed by the terminal according to the first embodiment.

FIG. 16 is a flowchart illustrating an example of a countermeasure planning process that is executed by a countermeasure planning device according to the first embodiment.

FIG. 17 is a diagram illustrating an image of a method of selecting a countermeasure in the first embodiment.

FIG. 18 is a flowchart illustrating an example of an external resource fulfillment determination process that is executed by the countermeasure planning device according to the first embodiment.

FIG. 19 is a diagram illustrating an image of resource matching in the first embodiment.

FIG. 20A is a diagram illustrating an example of a screen displayed by the terminal according to the first embodiment.

FIG. 20B is a diagram illustrating an example of a screen displayed by the terminal according to the first embodiment.

FIG. 21 is a diagram illustrating an example of a screen displayed by the terminal according to the first embodiment.

FIG. 22 is a flowchart illustrating an example of a dispatch plan making process that is executed by the countermeasure planning device according to the first embodiment.

FIG. 23A is a diagram illustrating an image of the dispatch plan making process in the first embodiment.

FIG. 23B is a diagram illustrating an image of the dispatch plan making process in the first embodiment.

FIG. 24 is a diagram illustrating an example of a screen displayed by the terminal according to the first embodiment.

FIG. 25 is a diagram illustrating an example of a screen displayed by the terminal according to the first embodiment.

### DESCRIPTION OF EMBODIMENTS

Hereinafter, embodiments of the present invention will be described using the drawings. Note that the contents described in the following embodiments are not intended to limit the present invention. A person skilled in the art can easily understand that a specific configuration of the present invention can be changed within a range not departing from the spirit of the present invention.

In a configuration of the present invention that is described below, the same or similar components or functions will be represented by the same reference numerals, and the description thereof will not be repeated.

In the present specification and the like, the expression “first”, “second”, “third”, or the like is added to distinguish between components, and does not always limit the number or order thereof.

For easy understanding of the present invention, the position, size, shape, range, and the like of each of the components illustrated in the drawings do not necessarily represent the actual ones. Accordingly, the present invention is not necessarily limited to the position, size, shape, range, and the like illustrated in the drawings.

### First Embodiment

In the first embodiment, a disaster countermeasure planning system that plans a countermeasure for disaster recovery in consideration of a resource that is externally provided will be described using a countermeasure relating to power supply during the occurrence of a disaster as an example. In the following description, the countermeasure for disaster recovery will be simply referred to as the countermeasure.

In the first embodiment, a local government that opens and operates a shelter for ensuring safe of local residents during the occurrence of a disaster, an operator of a facility for the disabled/the elderly where power supply during the occurrence of a disaster is critical, a business operator of a retail business/a restaurant business where the stock is in a freezer and blackout during the occurrence of a disaster is accompanied by opportunity loss, or the like is assumed as a business operator (countermeasure planner) that plans a countermeasure.

Regarding (1) a countermeasure where the business operator itself introduces resources such as an emergency generator by self-investment and (2) a countermeasure where an electric vehicle (EV) as an external resource is dispatched from a provider that owns EV's (for example, an individual, a business operator of a car rental business or a delivery business, or a corporation) during the occurrence of a disaster to supply power until blackout is recovered, the disaster countermeasure planning system selects a countermeasure having a high implementation probability while suppressing the cost in consideration of the amount of opportunity loss caused by a disaster and the cost required for the countermeasure.

In the following description, the countermeasure of (1) will be described as a self-investment countermeasure, and the countermeasure of (2) will be described as an external resource utilization countermeasure.

When the external resource utilization countermeasure is selected, the disaster countermeasure planning system determines whether dispatch of an EV is required after the occurrence of a disaster based on a blackout situation of a facility, and requests a registered provider of EV's for the dispatch. The provider gives a response regarding whether the dispatch is available for the request. The system makes an EV dispatch plan (resource provision plan) based on the response result, and actually requests for the EV dispatch.

Here, when the EV is used, an incentive is paid according to the request of the provider. Therefore, unless the incentive is appropriately set, the cost may increase to be higher than that of a case where the self-investment is executed. Accordingly, the system sets the incentive when the countermeasure is planned.

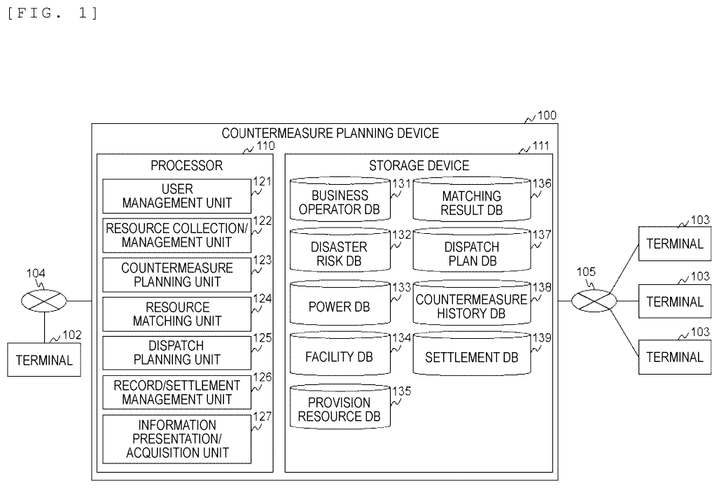

FIG. 1 is a block diagram illustrating an example of a configuration of the disaster countermeasure planning system according to the first embodiment.

The disaster countermeasure planning system includes a countermeasure planning device 100 and a plurality of terminals 102 and 103. The countermeasure planning device 100 is connected to the terminal 102 used by the business operator as the countermeasure planner through a network 104, and is connected to the terminal 103 used by the EV provider through a network 105. The networks 104 and 105 may be, for example, a network such as a local area network (LAN) or a wide area network (WAN), and the connection method may be wired or wireless. The networks 104 and 105 may be the same network.

The countermeasure planning device 100 includes a processor 110, a storage device 111, and a network interface (not illustrated). The countermeasure planning device 100 may include an input device such as a keyboard or a mouse and an output device such as a display.

By executing a program stored in the storage device 111, the processor 110 operates as a user management unit 121, a resource collection/management unit 122, a countermeasure planning unit 123, a resource matching unit 124, a dispatch planning unit 125, a record/settlement management unit 126, and an information presentation/acquisition unit 127. In the following description, it is assumed that, when a process is described using the functional unit, the processor 110 executes the process according to the program.

The storage device 111 stores, as databases used for the process, a business operator DB 131, a disaster risk DB 132, a power DB 133, a facility DB 134, a provision resource DB 135, a matching result DB 136, a dispatch plan DB 137, a countermeasure history DB 138, and a settlement DB 139.

Each of the terminals 102 and 103 is generally a personal computer (PC), a tablet terminal, or a smartphone, or the like and includes a processor, a memory, a network interface, an input device, and an output device (not illustrated).

The countermeasure planning device 100 may be implemented as a computer system configured with a plurality of computers, or may be implemented as a virtual computer.

A usage form of the disaster countermeasure planning system is as follows.

(Procedure 1) The countermeasure planner accesses the countermeasure planning device 100 using the terminal 102, registers information regarding a facility of a shelter or a store for which a countermeasure is to be executed, and collects provision of an EV to the facility. The EV provider accesses the countermeasure planning device 100 using the terminal 103 and registers an EV as a resource for an available facility.

(Procedure 2) The countermeasure planning device 100 plans and selects one or more countermeasures in consideration of an EV registration situation, the amount of opportunity loss during occurrence of a disaster, the cost of self-investment, and the like.

(Procedure 3) When a disaster occurs, the countermeasure planner determines whether dispatch of an EV is required based on a blackout situation of a facility for which the external resource utilization countermeasure is selected, and requests a registered EV provider for the EV dispatch. The EV provider gives a response regarding whether the dispatch is available for the request. The countermeasure planning device 100 makes an EV dispatch plan based on the response result, and requests the EV provider for the EV dispatch.

Next, data structures of the DB's managed by the countermeasure planning device 100 will be described.

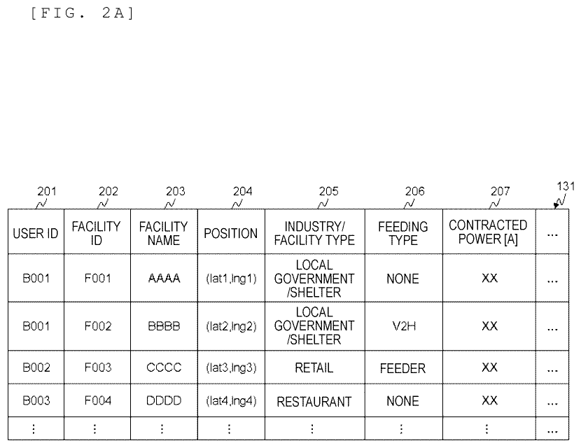

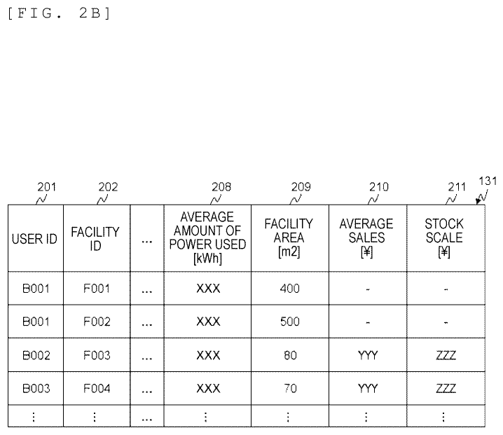

FIGS. 2A and 2B are diagrams illustrating an example of the data structure of the business operator DB 131 in the first embodiment. Due to the space of the drawing, the data structure is divided into the two drawings.

The business operator DB 131 is a database for managing information regarding the facility for which the countermeasure is to be executed.

The business operator DB 131 stores, for example, entries including a user ID 201, a facility ID 202, a facility name 203, a position 204, an industry/facility type 205, a feeding type 206, a contracted power 207, an average amount of power used 208, a facility area 209, an average sales 210, and a stock scale 211. One entry is present for one facility. The fields in the entries are not limited to the above-described examples. Any of the above-described fields may not be included, or another field may be included.

The feeding type 206 is a field that stores a supply type when power is supplied from the EV to the facility. “None” represents that a feeding facility is not present in the facility. “V2H” represents that Vehicle To Home is supported.

The average amount of power used 208 is a field that stores the average amount of power used per day. The average sales 210 is a field that stores the average sales per day. The stock scale 211 is a field that stores the scale of stock in the store. When the facility is the store, the values of the average sales 210 and the stock scale 211 are set. When the facility is the shelter, the facility for the disabled, or the like, the average sales 210 and the stock scale 211 are empty.

FIG. 3 is a diagram illustrating an example of the data structure of the disaster risk DB 132 in the first embodiment.

The disaster risk DB 132 is a database for managing a disaster occurrence risk of the area.

The disaster risk DB 132 stores, for example, entries including an area ID 301, a position 302, and a disaster risk 303. One entry is present for one area. The fields in the entries are not limited to the above-described examples. Any of the above-described fields may not be included, or another field may be included.

The disaster risk 303 is a field that stores probability of occurrence of a disaster. The probability may be set depending on the type of the disaster.

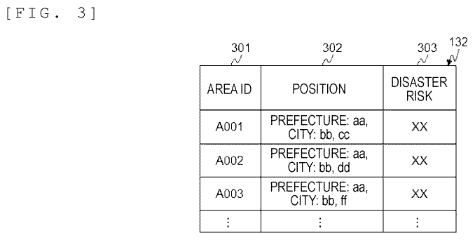

FIG. 4 is a diagram illustrating an example of the data structure of the power DB 133 in the first embodiment.

The power DB 133 is a database for managing information regarding power consumptions of devices provided in the facility. The power DB 133 is used for estimating the required amount of power for the facility.

The power DB 133 stores, for example, entries including a device name 401, an outlet 402, a V2H 403, a shelter 404, a retail/restaurant 405, a power consumption 406, a required number of devices 407, and a usage time 408. One entry is present for one device. The fields in the entries are not limited to the above-described examples. Any of the above-described fields may not be included, or another field may be included.

The outlet 402 is a field that stores a flag representing whether the feeding type of the device supports the outlet. When the feeding type of the device supports the outlet, the outlet 402 stores “1”. The V2H 403 is a field that stores a flag representing whether the feeding type of the device supports the V2H. When the feeding type of the device supports the V2H, the V2H 403 stores “1”.

The shelter 404 is a field that stores a flag representing whether the device assumes standard use in the shelter. When the device assumes the standard use in the shelter, the shelter 404 stores “1”. The retail/restaurant 405 is a field that stores a flag representing whether the e assumes standard use in the store of a retail business/a restaurant business. When the device assumes the standard use in the store of a retail business/a restaurant business, the retail/restaurant 405 stores “1”.

The power consumption 406 is a field that stores power consumed in one device. The required number of devices 407 is a field that stores the required number of devices per unit area. Here, the unit area is assumed as 100 m². The usage time 408 is a field that stores the standard usage time of the device per day.

The power consumption and the like vary depending on the seasons. Therefore, the power consumption, the required number of devices, and the usage time may be managed depending on the seasons such as the summer, the winter, and the in-between season.

The countermeasure planning device 100 estimates required power in the facility during the occurrence of a disaster using the business operator DB 131 and the power DB 133.

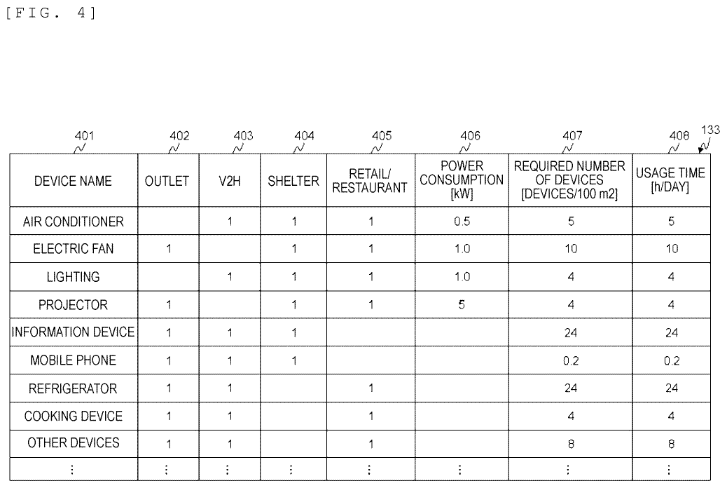

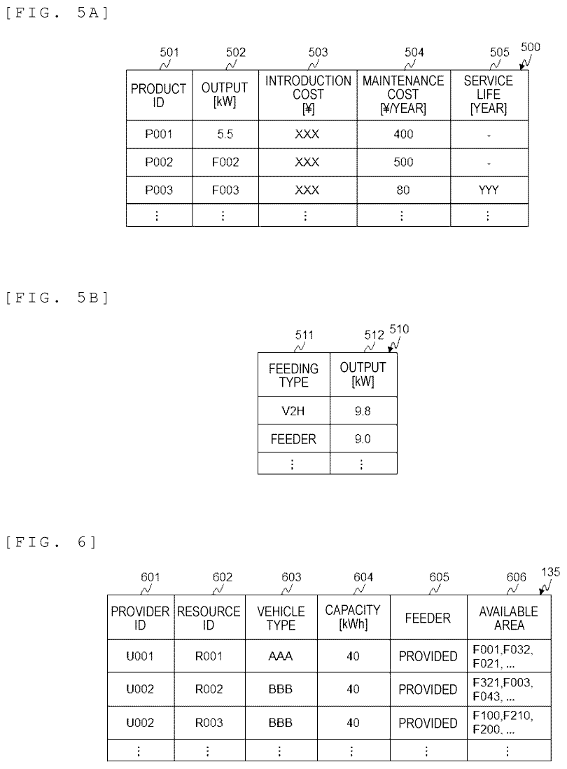

FIGS. 5A and 5B are diagrams illustrating an example of the data structure of the facility DB 134 in the first embodiment.

The facility DB 134 stores emergency power supply information 500 and feeding information 510.

The emergency power supply information 500 stores information regarding the specification and the cost of an emergency generator. The emergency power supply information 500 stores, for example, entries including a product ID 501, an output 502, an introduction cost 503, and a maintenance cost 504, and a service life 505. One entry is present for one emergency generator. The fields in the entries are not limited to the above-described examples. Any of the above-described fields may not be included, or another field may be included.

After estimating the required power for the facility during the occurrence of a disaster, the countermeasure planning device 100 refers to the output 502 based on the power, selects the introduced emergency generator, and estimates the cost of the self-investment.

The feeding information 510 stores information regarding the maximum output of each of the EV feeding types (V2H and an outlet feeding type feeder). The feeding information 510 stores, for example, entries including a feeding type 511 and an output 512. One entry is present for one feeding type. The fields in the entries are not limited to the above-described examples. Any of the above-described fields may not be included, or another field may be included.

When the required power for the facility during the occurrence of a disaster, is higher than the maximum output of the EV feeding type, the required power cannot be handled by the feeding using an EV.

FIG. 6 is a diagram illustrating an example of the data structure of the provision resource DB 135 in the first embodiment.

The provision resource DB 135 is a database for managing information regarding EV's registered by the provider. The provision resource DB 135 stores, for example, entries including a provider ID 601, a resource ID 602, a vehicle type 603, a capacity 604, a feeder 605, and an available area 606. One entry is present for one EV. The fields in the entries are not limited to the above-described examples. Any of the above-described fields may not be included, or another field may be included.

The capacity 604 is a field that stores the power capacity of the EV. The feeder 605 is a field that stores a flag representing whether the provider can provide the EV together with an outlet type feeder. When the EV can be provided together with the outlet type feeder, the feeder 605 stores “Provided”.

The available area 606 is a field that stores the areas where the EV is available. The available area 606 stores a list of identification information of the facilities set in the facility ID 202.

The EV provider accesses the countermeasure planning device 100 using the terminal 103 and registers the EV as a resource for the available facility. The registration result is stored in the provision resource DB 135.

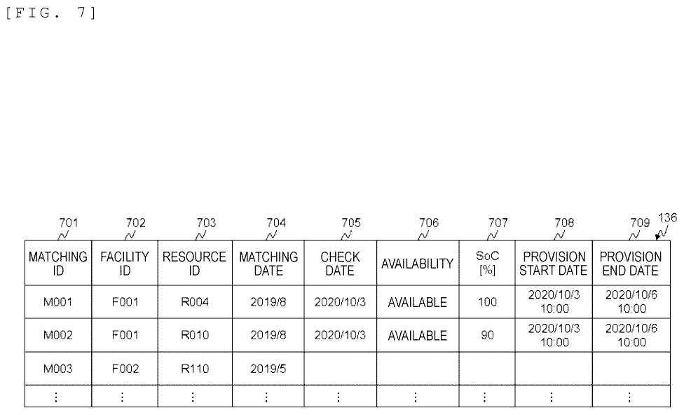

FIG. 7 is a diagram illustrating an example of the data structure of the matching result DB 136 in the first embodiment.

The matching result DB 136 is a database for managing a matching result and a provision record of the EV in the external resource utilization countermeasure. The matching result DB 136 stores, for example, entries including a matching ID 701, a facility ID 702, a resource ID 703, a matching date 704, a check date 705, an availability 706, a SoC 707, a provision start date 708, and a provision end date 709. One entry is present for a combination of the facility and the EV. The fields in the entries are not limited to the above-described examples. Any of the above-described fields may not be included, or another field may be included.

The matching date 704 is a field that stores the date when matching is executed. The check date 705 is a field that stores the data when whether the EV is available is checked after the occurrence of a disaster. The availability 706 is a field that stores a response to an inquiry about whether the EV is available. The SoC 707 is a field that stores the state of charge of the EV. The provision start date 708 and the provision end date 709 are fields that store the time when the EV is actually provided and the time when the EV is returned.

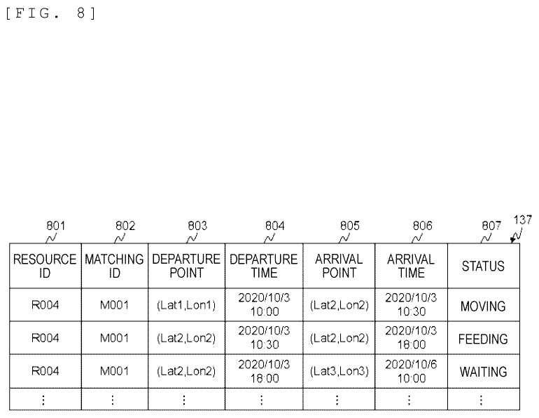

FIG. 8 is a diagram illustrating an example of the data structure of the dispatch plan DB 137 in the first embodiment.

The dispatch plan DB 137 is a database for managing a plan regarding the dispatch of the EV to the facility. The dispatch plan DB 137 stores, for example, entries including a resource ID 801, a matching ID 802, a departure point 803, a departure time 804, an arrival point 805, an arrival time 806, and a status 807. One entry is present for a combination of the status, the departure point, and the arrival point of the EV. The fields in the entries are not limited to the above-described examples. Any of the above-described fields may not be included, or another field may be included.

The dispatch plan DB 137 illustrated in FIG. 8 stores entry groups representing dispatch plans where an EV having a resource ID of “R004” moves from the provision location to the facility, executes feeding in the facility, and moves to any point and waits after the feeding.

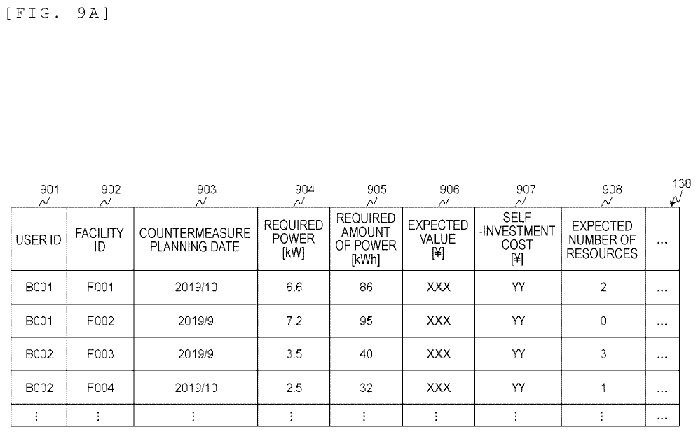

FIGS. 9A and 9B are diagrams illustrating an example of the data structure of the countermeasure history DB 138 in the first embodiment. Due to the space of the drawing, the data structure is divided into the two drawings.

The countermeasure history DB 138 is a database for managing history of a planned countermeasure. The countermeasure history DB 138 stores, for example, entries including a user ID 901, a facility ID 902, a countermeasure planning date 903, a required power 904, a required amount of power 905, an expected value 906, a self-investment cost 907, an expected number of resources 908, a cost upper limit 909, a fulfillment 910, a number of resources 911, and a countermeasure 912. The fields in the entries are not limited to the above-described examples. Any of the above-described fields may not be included, or another field may be included.

The required power 904 is a field that stores required power for the facility during the occurrence of a disaster. The required amount of power 905 is a field that stores a required amount of power for the facility the during occurrence of a disaster.

The expected value 906 is a field that stores an expected value (amount) of opportunity loss. The self-investment cost 907 is a field that stores a cost required for the self-investment countermeasure. The expected number of resources 908 is a field that stores an expected number of EV's to be provided. The cost upper limit 909 is a field that stores an upper limit amount of the cost of the external resource utilization countermeasure.

The fulfillment 910 is a field that stores a value representing whether an EV for covering the power and the amount of power can be ensured. The number of resources 911 is a field that stores the number of EV's matched in the matching process. The countermeasure 912 is a field that stores the selected countermeasure.

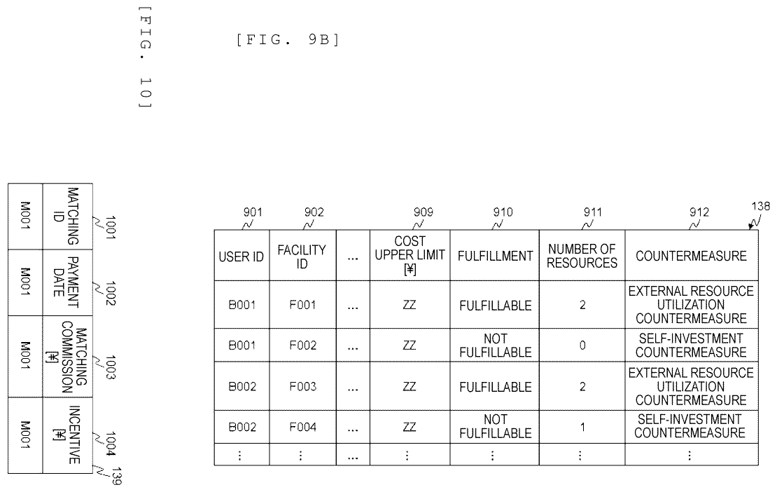

FIG. 10 is a diagram illustrating an example of the data structure of the settlement DB 139 in the first embodiment.

The settlement DB 139 is a database for managing a matching commission that is paid from the countermeasure planner to the operator of the countermeasure planning device 100 during the matching process and an incentive that is paid from the countermeasure planner to the EV provider. The settlement DB 139 stores, for example, entries including a matching ID 1001, a payment date 1002, a matching commission 1003, and an incentive 1004. One entry is present for the payment of the matching commission or the incentive. The fields in the entries are not limited to the above-described examples. Any of the above-described fields may not be included, or another field may be included.

Next, the details of the process that is executed by the countermeasure planning device 100 will be described.

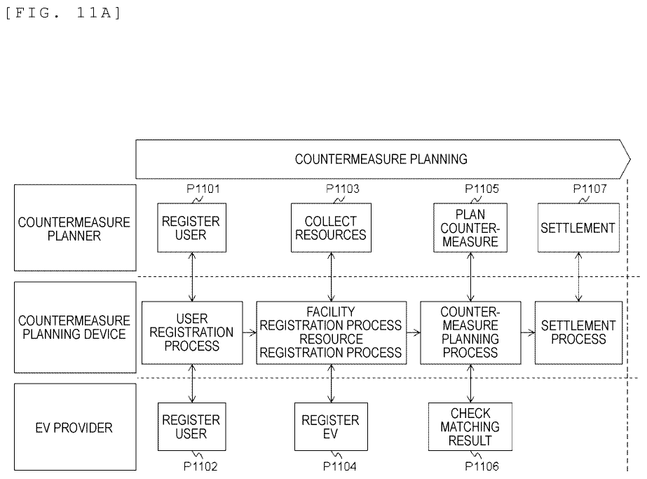

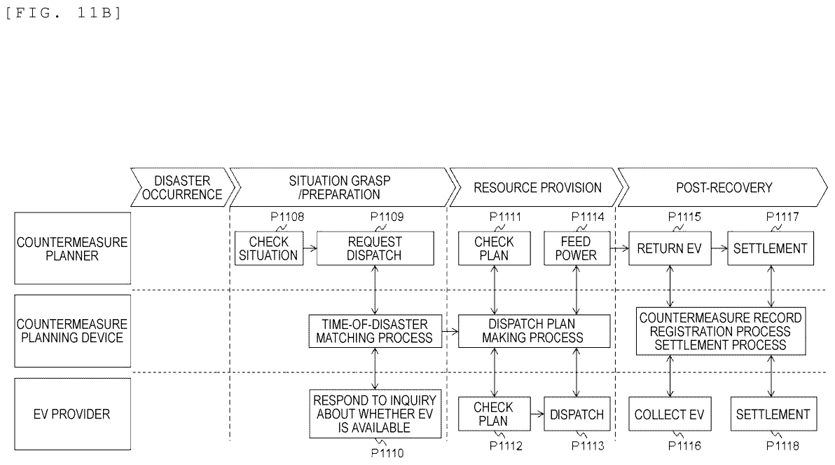

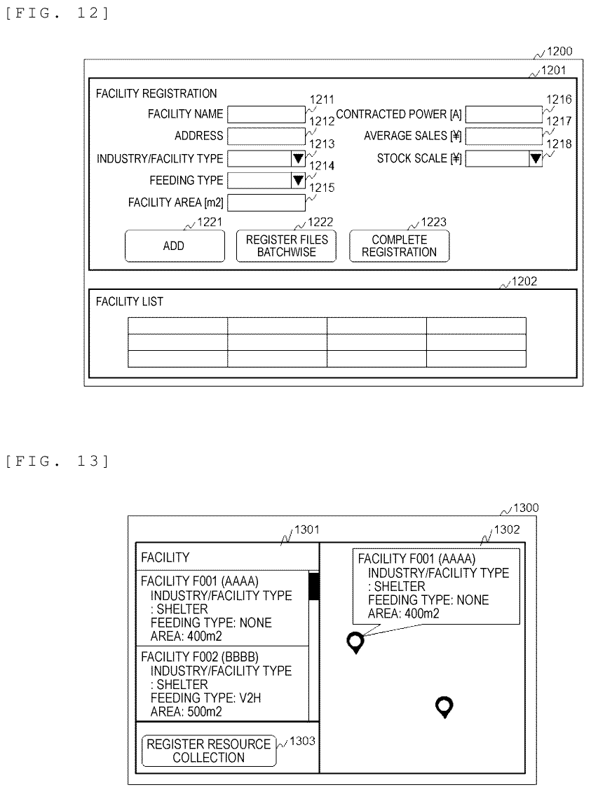

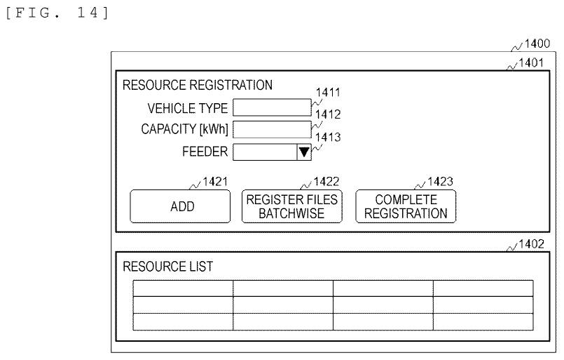

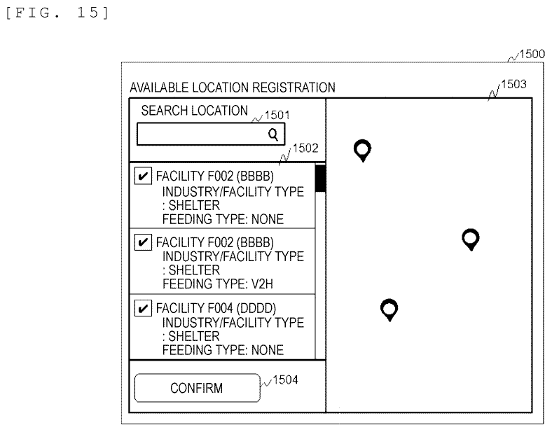

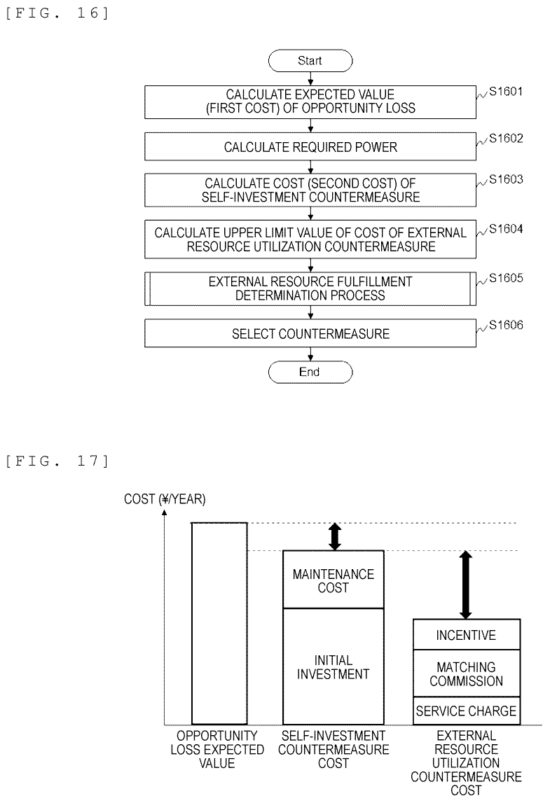

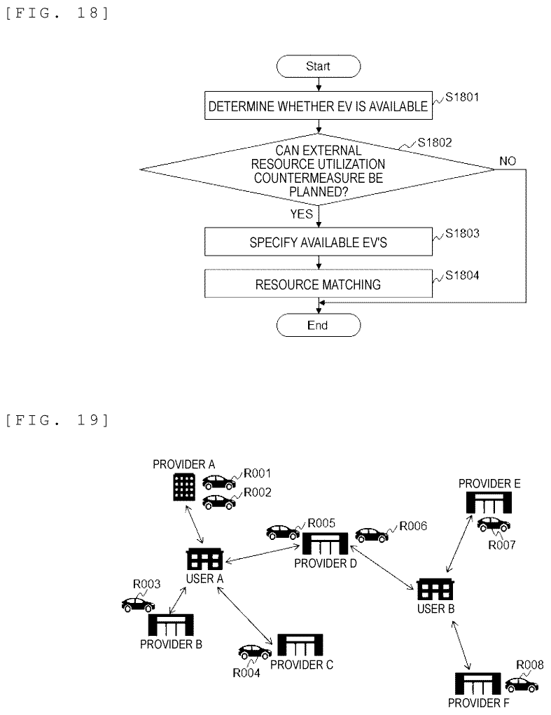

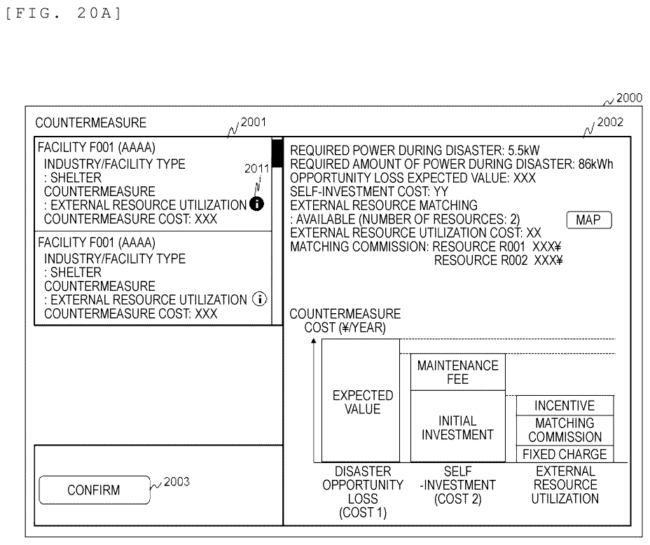

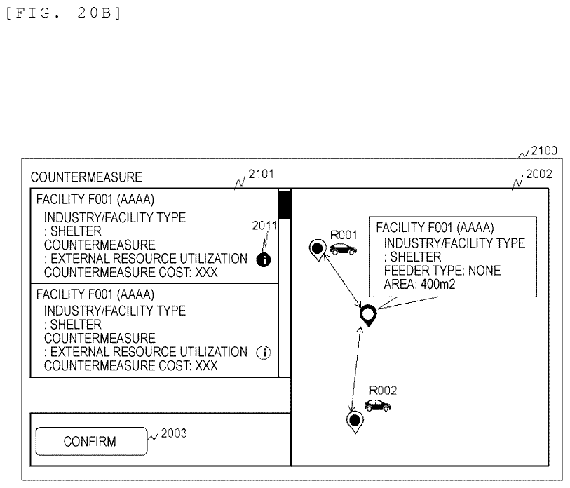

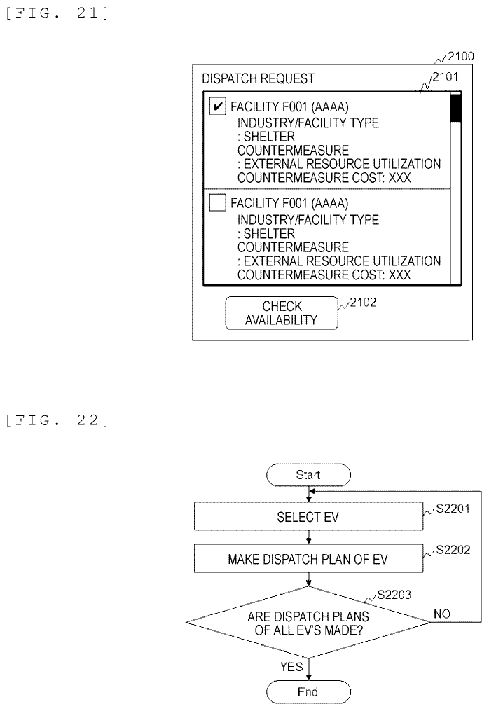

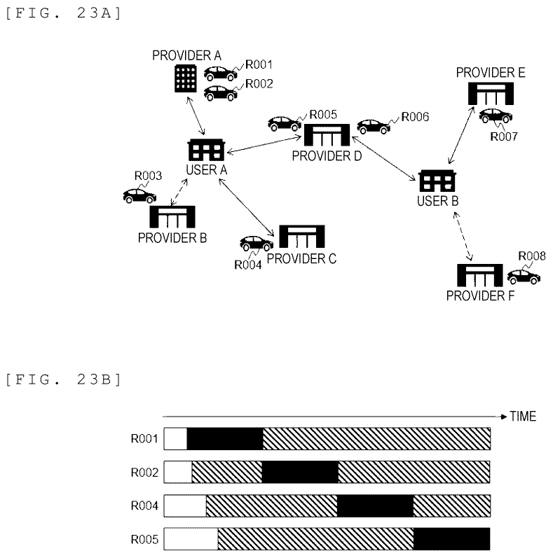

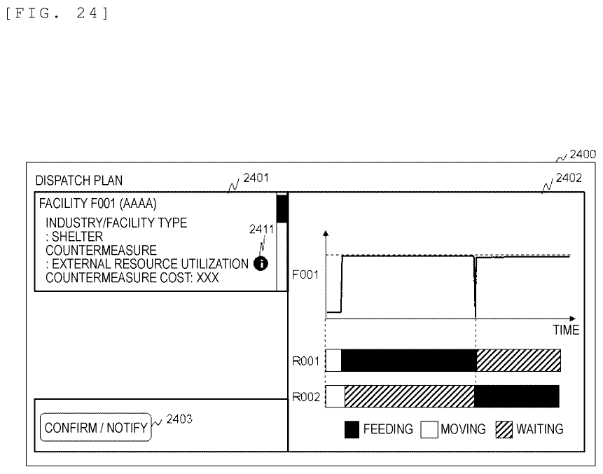

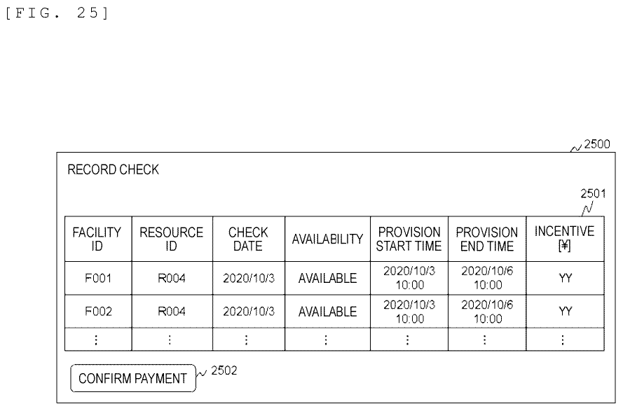

FIGS. 11A and 11B are diagrams illustrating an example of a usage flow of the countermeasure planning system according to the first embodiment. FIGS. 12 and 13 are diagrams illustrating examples of screens displayed by the terminal 102 according to the first embodiment. FIGS. 14 and 15 are diagrams illustrating examples of screens displayed by the terminal 103 according to the first embodiment. FIG. 16 is a flowchart illustrating an example of a countermeasure planning process that is executed by the countermeasure planning device 100 according to the first embodiment. FIG. 17 is a diagram illustrating an image of a method of selecting a countermeasure in the first embodiment. FIG. 18 is a flowchart illustrating an example of an external resource fulfillment determination process that is executed by the countermeasure planning device 100 according to the first embodiment. FIG. 19 is a diagram illustrating an image of resource matching in the first embodiment. FIGS. 20A and 20B are diagrams illustrating examples of screens displayed by the terminal 102 according to the first embodiment. FIG. 21 is a diagram illustrating an example of a screen displayed by the terminal 102 according to the first embodiment. FIG. 22 is a flowchart illustrating an example of a dispatch plan making process that is executed by the countermeasure planning device 100 according to the first embodiment. FIGS. 23A and 23B are diagrams illustrating an image of the dispatch plan making process in the first embodiment. FIGS. 24 and 25 are diagrams illustrating examples of screens displayed by the terminal 102 according to the first embodiment.

FIGS. 11A and 11B are diagrams illustrating the usage flow of the countermeasure planning device 100 and illustrating exchange between the countermeasure planner, the EV provider, and the countermeasure planning device 100. The usage flow can be divided into a countermeasure planning phase, a disaster occurrence phase, a situation grasp/preparation phase, a resource provision phase, and a post-recovery phase. Hereinafter, the details of an operation and a process of the phases will be described.

The countermeasure planner accesses the countermeasure planning device 100 using the terminal 102, and the EV provider accesses the countermeasure planning device 100 using the terminal 103.

First, the countermeasure planning phase will be described.

The countermeasure planner and the EV provider execute user registration for using a service of the countermeasure planning device 100 (P1101, P1102). The user management unit 121 of the countermeasure planning device 100 executes a user registration process.

The countermeasure planner executes an operation of registering the facility and collecting the resource (P1103). Specifically, the resource collection/management unit 122 causes the terminal 102 to display screens 1200 and 1300 illustrated in FIGS. 12 and 13 through the information presentation/acquisition unit 127.

First, the terminal 102 displays the screen 1200. The screen 1200 includes a facility registration field 1201 and a facility list field 1202. The facility registration field 1201 is a field for registering the facility, and includes input fields 1211, 1212, 1213, 1214, 1215, 1216, 1217, and 1218 and operation buttons 1221, 1222, and 1223.

The countermeasure planner inputs values to the input fields 1211 to 1218, registers the information of the facility in the business operator DB 131 when the operation button 1221 is pressed, and displays the information of the facility registered in the facility list field 1202. The same operation is repeatedly executed until all the facilities are registered, and the operation button 1223 is pressed after registering all the facilities. When a plurality of facilities are registered batchwise, the countermeasure planner presses the operation button 1222 to input a CSV file or the like.

Regarding the facility where opportunity loss does not occur, for example, the shelter in the business/facility type, the input to the input fields 1217 and 1218 and the like is disabled.

When the operation button 1223 is pressed, the terminal 102 displays the screen 1300. The screen 1300 includes a facility display field 1301, a detail display field 1302, and an operation button 1303. The facility display field 1301 is a field that displays information of the registered facility, and the detail display field 1302 is a field that displays a map showing a location of the registered facility. The countermeasure planner checks the facility display field 1301 and the detail display field 1302, and presses the operation button 1303 for starting the collection of the resource.

The EV provider refers to the resource collection of the countermeasure planner, and registers the EV to be provided (P1104). Specifically, the resource collection/management unit 122 causes the terminal 103 to display screens 1400 and 1500 illustrated in FIGS. 14 and 15 through the information presentation/acquisition unit 127.

First, the terminal 103 displays the screen 1400. The screen 1400 includes a resource registration field 1401 and a resource list field 1402. The resource registration field 1401 field for registering the resource, and includes input fields 1411, 1412, and 1413 and operation buttons 1421, 1422, and 1423.

The EV provider inputs values to the input fields 1411 to 1413, registers the information of the EV in the provision resource DB 135 when the operation button 1421 is pressed, and displays the information of the EV registered in the resource list field 1402. At this point, the available area 606 is empty. The same operation is repeatedly executed until all the EV's are registered, and the operation button 1423 is pressed after registering all the EV's. When a plurality of EV's are registered batchwise, the EV provider presses the operation button 1422 to input a CSV file or the like.

When the operation button 1423 is pressed, the terminal 103 displays the screen 1500. The screen 1500 includes a search field 1501, a facility display field 1502, a detail display field 1503, and an operation button 1504. The search field 1501 is a field for searching for the facility for which the resource is being collected. The EV provider inputs an address or the like to the search field 1501. The resource collection/management unit 122 searches for the facility where the resource is being collected in the vicinity of the input address, displays the information of the facility in the facility display field 1502, and displays a map showing the facility in the detail display field 1503. In FIG. 15, three facilities are displayed. The EV provider operates a check box of the facility display field 1502 to select the facility for which it is desired to provide the EV, and presses the operation button 1504. Through the operation, the identification information of the facility is stored in the available area 606.

The countermeasure planner requests the countermeasure planning device 100 for planning the countermeasure (P1105). The countermeasure planning device 100 executes the countermeasure planning process. Here, the countermeasure planning process will be described using FIGS. 16 and 17.

In the countermeasure planning process, the countermeasure planning device 100 executes the following process on one facility. Here, a process to be executed on a facility f_a will be described as an example.

First, the countermeasure planning unit 123 calculates the expected value (first cost) of opportunity loss based on the business operator DB 131 and the disaster risk DB 132 (Step S1601). In the facility where the opportunity loss does not occur, the process of Step S1601 is skipped.

The countermeasure planning unit 123 acquires the entry of the facility from the business operator DB 131, refers to the disaster risk DB 132 based on the position 204 of the entry, and acquires the value of the disaster risk 303 of the entry corresponding to the area where the facility is present. The countermeasure planning unit 123 calculates a first cost cost1_a using Expression (1). Here, a is a character for identifying the facility, sale a represents the value of the average sales 210, stock a represents the value of the stock scale 211, and risk a represents the value of the disaster risk 303.

$$\begin{matrix}[ Mathematical Expression 1 ] & \\ cost {1}_{a} = {( sales}_{a} * 3 + {stock}_{a} ) * {risk}_{a} & ( 1 )\end{matrix}$$

Expression (1) is an expression for calculating the total value of the expected values of opportunity loss when the sales and the loss of stock during three days (72 hours) from the occurrence of a disaster are assumed. Expression (1) is merely an example, and the method of calculating the first cost is not limited thereto.

Next, the countermeasure planning unit 123 calculates the required power of the facility based on the business operator DB 131 and the power DB 133 (Step S1602). Specifically, the following process is executed.

(S1602-1) The countermeasure planning unit 123 specifies the type of the facility based on the industry/facility type 205 of the entry of the facility, and specifies the feeding type based on the feeding type 206. The countermeasure planning unit 123 refers to the power DB 133, and specifies the device used for the facility during the occurrence of a disaster based on the values of the shelter 404, the retail/restaurant 405, the outlet 402, and the V2H 403. For example, when the industry/facility type 205 is “local government/shelter” and the feeding type 206 is “V2H”, the countermeasure planning unit 123 searches for the entry where “1” is stored in each of the V2H 403 and the shelter 404.

(S1602-2) The countermeasure planning unit 123 calculates the number of the specified devices based on the facility area 209 of the entry of the facility and the required number of devices 407 of the entry of the searched device. Further, the countermeasure planning unit 123 calculates the required power (kwh) of the device during three days from the occurrence of a disaster using the power consumption 406 and the usage time 408 of the entry of the specified device.

Next, the countermeasure planning unit 123 calculates the cost of the self-investment countermeasure (second cost) based on the required power of the facility and the emergency power supply information 500 (Step S1603). The countermeasure planning unit 123 manages the first cost and the second cost as cost information.

Specifically, the countermeasure planning unit 123 specifies an emergency power supply that fulfills the required power of the facility based on the output 502 of each of the entries of the emergency power supply information 500. That is, the self-investment countermeasure is made. The countermeasure planning unit 123 calculates a cost cost2 a of the self-investment countermeasure based on the above-described results. The cost of the self-investment countermeasure is calculated, for example, using Expression (2). Here, icost_a represents the value of the introduction cost 503, occost_a represents the value of the maintenance cost 504, and y_a represents the value of the service life 505.

$$\begin{matrix}[ Mathematical Expression 2 ] & \\ cost {2}_{a} = \frac{i c o s {t}_{a}}{{y}_{a}} + o c o s {t}_{a} & ( 2 )\end{matrix}$$

Next, the countermeasure planning unit 123 calculates the upper limit value of the cost of the external resource utilization countermeasure based on the first cost and the second cost (Step S1604).

Here, the first cost, the second cost, and the cost of the external resource utilization countermeasure are represented by a relationship illustrated in FIG. 17. When the cost f the external resource utilization countermeasure is higher than a smaller cost among the first cost and the second cost, a countermeasure other than the utilization of the external resource is desirable. The cost of the external resource utilization countermeasure is the sum of a fixed charge (annual amount) of a service provided by the countermeasure planning device 100, the matching commission paid at the time of matching establishment, and the incentive paid to the EV provider according to the provision record of the EV. Accordingly, an upper limit value costST_a of the cost of the external resource utilization countermeasure can be represented by Expression (3). Here, PROFIT is a parameter for determining the upper limit value of the cost of the external resource utilization countermeasure, and represents that the cost of the external resource utilization countermeasure is determined such that the countermeasure planner acquires a profit corresponding to “PROFIT” from the smaller cost among the first cost and the second cost.

$$\begin{matrix}[ Mathematical Expression 3 ] & \\ c o s t S {T}_{a} = min ( cost {1}_{a} , cost {2}_{a} ) * ( 1 - PROFIT ) & ( 3 )\end{matrix}$$

Next, the resource matching unit 124 executes the external resource fulfillment determination process (Step S1605). Here, the details of the external resource fulfillment determination process will be described using FIGS. 18 and 19.

The resource matching unit 124 determines whether the EV is available based on the required power of the facility (Step S1801).

Specifically, the resource matching unit 124 refers to the feeding type 511 of the feeding information 510, and specifies the entry corresponding to the feeding type of the device required for the facility. When the value of the output 512 of the specified entry is lower than the power of the device, the resource matching unit 124 determines that the EV is not available.

The resource matching unit 124 determines whether the external resource utilization countermeasure can be planned based on the determination result of Step S1801 (Step S1802).

When the external resource utilization countermeasure cannot be planned, the resource matching unit 124 ends the external resource fulfillment determination process. At this time, the resource matching unit 124 outputs “Not Plannable of External Resource Utilization Countermeasure” to the countermeasure planning unit 123. In this case, the external resource utilization countermeasure is excluded from the options.

When the external resource utilization countermeasure cannot be planned, the resource matching unit 124 specifies the available EV (Step S1803).

Specifically, the resource matching unit 124 refers to the provision resource DB 135, and searches for the entry where the available area 606 includes the identification information of the facility and the feeding type of the EV matches with the feeding type of the facility.

The resource matching unit 124 executes resource matching (Step S1804), and subsequently ends the external resource fulfillment determination process.

Specifically, the resource matching unit 124 solves an optimization problem represented by Expression (4) under constraint conditions of Expressions (5) and (6). Expression (4) is a linear programming problem, and acquires a combination of flags of whether (1 or 0) x_a, e, and EV_e to be maximized are allocated to the facility. That is, the optimization problem represented by Expression (4) is a problem for calculating a combination of the facility and the EV where the amount of power supplied to each of the facilities is maximized and the moving distance of the EV and the sum of the matching commission and the incentive are minimized.

supplyTGT_a represents a desired amount of power supplied to the facility, reliability_a represents the dispatch probability of the facility, travelT_a, e represents the travel time of EV_e to the facility, unitsupply_e represents the facility unit supply amount of EV_e, incentive_a, e represents the incentive for the facility of EV_e, commision_a, e represents the matching commission of EV_e and the facility a, and w_1, w_2, and w_3 represent the weights. Regarding the matching commission and the incentive, for example, a base cost is previously set.

$$\begin{matrix}[ Mathematical Expression 4 ] & \\ Maximize {w}_{1} \times {\sum }_{a} {\sum }_{e} ( {x}_{a , e} * {unitsupply}_{e} ) - {w}_{2} \times {\sum }_{a} {\sum }_{e} ( {x}_{a , e} * t r a v e l {T}_{a , e} ) - {w}_{3} \times {\sum }_{a} {\sum }_{e} ( {x}_{a , e} * ( {comm ission}_{a , e} + {inse ntive}_{a , e} * {risk}_{a} ) ) & ( 4 )\end{matrix}$$

$$\begin{matrix}[ Mathematical Expression 5 ] & \\ ∀ a {\sum }_{e} ( {x}_{a , e} * {unitsupply}_{e} ) \leq s u p p l y T G {T}_{a} / {reliability}_{a} & ( 5 )\end{matrix}$$

$$\begin{matrix}[ Mathematical Expression 6 ] & \\ ∀ a {\sum }_{e} ( {x}_{a , e} * ( {comm ission}_{a , e} + {inse ntive}_{a , e} * {risk}_{a} ) ) \leq c o s t S {T}_{a} & ( 6 )\end{matrix}$$

Expression (5) represents that the required supply amount of each of the facilities needs to be satisfied by the amount of power supplied by the EV. Expression (6) represents that the upper limit of the cost of the external resource utilization countermeasure of each of the facilities is prevented from being exceeded.

Based on previous data of the matching result DB 136, matching with the target facility may be established and the proportion of available EV's may be calculated and used as the dispatch probability.

FIG. 19 represents an image of resource matching. Six EV providers are present around a facility of a user A and a facility of a user B, the facility of the user A is matched with resources owned by a provider A, a provider B, a provider C, and a provider D, and the facility of the user B is matched with resources owned by the provider D, a provider E, and a provider F.

When the solution is obtained, the resource matching unit 124 outputs not only the matching result but also “Plannable of External Resource Utilization Countermeasure” to the countermeasure planning unit 123. In addition, when the solution that satisfies the constraint conditions cannot be obtained due to the registration situation of the EV's, for example, when no EV's are present around the facility, the resource matching unit 124 outputs “Not Plannable of External Resource Utilization Countermeasure” to the countermeasure planning unit 123.

The external resource fulfillment determination process has been described above. The description will be continued referring back to FIG. 16.

The countermeasure planning unit 123 selects the countermeasure based on the first cost, the second cost, and the result of the external resource fulfillment determination process (Step S1606).

Specifically, when “Plannable of External Resource Utilization Countermeasure” is obtained as the result of the external resource fulfillment determination process, the countermeasure planning unit 123 selects the external resource utilization countermeasure. When “Not Plannable of External Resource Utilization Countermeasure” is obtained as the result of the external resource fulfillment determination process and the first cost is higher than or equal to the second cost, the countermeasure planning unit 123 selects the self-investment countermeasure. When “Not Plannable of External Resource Utilization Countermeasure” is obtained the result of the external resource fulfillment determination process and the first cost is lower than the second cost, the countermeasure planning unit 123 selects “Do Nothing” as the countermeasure.

When the first cost is not present and “Not Plannable of External Resource Utilization Countermeasure” is obtained as the result of the external resource fulfillment determination process, the countermeasure planning unit 123 selects the self-investment countermeasure.

The countermeasure planning unit 123 adds the entry to the countermeasure history DB 138, and sets the results of the series of processes in each of the fields of the entry. When the external resource utilization countermeasure is selected, the countermeasure planning unit 123 reflects the result of resource matching on the matching result DB 136. At this time, fields other than the matching ID 701, the facility ID 702, the resource ID 703, and the matching date 704 of the entry stored in the matching result DB 136 are empty.

The countermeasure planning unit 123 causes the terminal 102 that is operated by the countermeasure planner to display information regarding the selected countermeasure through the information presentation/acquisition unit 127. For example, the countermeasure planning unit 123 displays screens illustrated in FIGS. 20A and 20B.

The terminal 102 displays a screen 2000 illustrated in FIG. 20A. The screen 2000 includes a countermeasure display field 2001, a detail display field 2002, and an operation button 2003. The countermeasure display field 2001 is a field that displays the countermeasure for each of the facilities. The detail display field 2002 is a field that displays detailed information regarding the planning of the countermeasure, and displays the information when an icon 2011 is pressed. The detail display field 2002 displays a graph, required power, a commission, and the like of the cost. When the external resource utilization countermeasure is selected, the detail display field 2002 displays a map button. When the button is pressed, as illustrated in FIG. 20B, the detail display field 2002 displays a map on which the matching result is superimposed. The countermeasure planner checks the selected countermeasure and presses the operation button 2003 to confirm the countermeasure.

At least any one of the first cost and the second cost may be input by the countermeasure planner. When the first cost is input, the process of Step S1601 can be skipped. When the second cost is input, the process of Step S1603 can be skipped.

Hereinabove, the countermeasure planning process has been described. The description will be continued referring back to FIG. 11A. In the following description, it is assumed that the external resource utilization countermeasure is selected as a result of executing the countermeasure planning process.

The countermeasure planning device 100 notifies the EV provider of the matching result, and the EV provider checks the matching result (P1106).

The countermeasure planner pays the matching commission to the operator of the countermeasure planning device 100 (P1107). The record/settlement management unit 126 of the countermeasure planning device 100 executes a settlement process. Specifically, the record/settlement management unit 126 adds the entry to the settlement DB 139, and sets the values to the matching ID 1001, the payment date 1002, and the matching commission 1003 of the entry.

Hereinabove, the usage flow of the countermeasure planning phase has been described. Next, by using a case where the external resource utilization countermeasure is executed after the occurrence of a disaster as an example, the usage flow including the disaster occurrence phase, the situation grasp/preparation phase, the resource provision phase, and the post-recovery phase will be described.

In the first embodiment, a usage method of dispatching the EV to the facility after the occurrence of a disaster is assumed. When the occurrence of a disaster such as a typhoon can be predicted, a usage method of dispatching the EV to the facility before the occurrence of the disaster to prepare the disaster may also be used.

After planning a countermeasure once, the countermeasure planner may request to plan a countermeasure again. Depending on a change in situation, an optimum countermeasure can be selected. For example, the self-investment countermeasure can be changed to the external resource utilization countermeasure.

After a disaster occurs (disaster occurrence phase), the countermeasure planner checks a damage situation in the situation grasp/preparation phase (P1108). For example, whether blackout occurs in the facility is checked. When the countermeasure planner determines that the external resource utilization countermeasure needs to be executed, the countermeasure planner operates the terminal 102 to request the countermeasure planning device 100 for the EV dispatch (P1109). Specifically, the information presentation/acquisition unit 127 causes the terminal 102 to display a screen 2100 illustrated in FIG. 21.

The screen 2100 includes a facility selection field 2101 and an operation button 2102. The facility selection field 2101 is a field that selects the facility for which the EV dispatch is requested. The facility selection field 2101 displays only the facility for which the external resource utilization countermeasure is selected. The countermeasure planner operates a check box to select the facility for which the EV dispatch is requested, and presses the operation button 2102.

When the dispatch request is received, the dispatch planning unit 125 of the countermeasure planning device 100 inquires about whether the EV is available to the EV provider based on the matching result of the selected facility. Together with the inquiry about whether the EV is available, the state of charge of the EV may be inquired.

The EV provider determines whether the EV is available and gives a response for the inquiry from the countermeasure planning device 100 (P1110).

The dispatch planning unit 125 sets the content of the response to the availability 706 of the corresponding entry of the matching result DB 136. When the state of charge of the EV is also inquired, the dispatch planning unit 125 sets the content of the response to the SoC 707 of the corresponding entry of the matching result DB 136.

The dispatch planning unit 125 executes a time-of-disaster matching process based on the response. Specifically, the dispatch planning unit 125 matches the available EV with the facility by newly solving the optimization problem represented by Expression (4). Further, the dispatch planning unit 125 executes the dispatch plan making process based on the result of the time-of-disaster matching process. The dispatch planning unit 125 transmits the made dispatch plan to the countermeasure planner and the EV provider. Here, the dispatch plan making process will be described using FIG. 22.

The dispatch planning unit 125 selects the resource from the available EV's (Step S2201). Here, the dispatch planning unit 125 selects the resource in order from the EV having the closest distance between the facility and the EV provider.

The dispatch planning unit 125 makes the dispatch plan from the provider of the selected EV to the facility (Step S2202).

The dispatch planning unit 125 determines whether the dispatch plans of all the available EV's are made (Step S2203). The dispatch planning unit 125 stores the made dispatch plans in the dispatch plan DB 137.

When the dispatch plans of all the available EV's are not made, the dispatch planning unit 125 returns to Step S2201 and executes the same process.

When the dispatch plans of all the available EV's are made, the dispatch planning unit 125 ends the dispatch plan making process.

FIG. 23A illustrates the matching result on which the response result from the EV provider is reflected. The facility of the user A is matched with fives EV's including EV (R001), EV (R002), EV (R003), EV (R004), and EV (R005). The response that the EV is not available is received from the provider B. Therefore, four EV's including EV (R001), EV (R002), EV (R004), and EV (R005) are provided to the facility of the user A. For each of the four EV's, for example, the dispatch plan illustrated in FIG. 23B is made. The white portion represents moving, the black portion represents feeding, and the hatched portion represents waiting.

By dispatching the EV's to execute feeding in order from the EV having the closest distance from the facility, the rapid and continuous power supply during three days from the occurrence of a disaster can be implemented. In FIG. 23B, when one EV executes feeding, the EV's arrived at the facility are waiting.

Hereinabove, the dispatch plan making process has been described. The description will be continued referring back to FIG. 11B.

In the resource provision phase, the countermeasure planner checks the dispatch plan (P1111). For example, the dispatch planning unit 125 causes the terminal 102 to display a screen 2400 illustrated in FIG. 24 through the information presentation/acquisition unit 127. The screen 2400 includes a facility display field 2401, a dispatch plan display field 2402, and an operation button 2403. The dispatch plan display field 2402 is a field that displays the details of the EV dispatch plan to the facility, and displays the information when an icon 2411 is pressed. The dispatch plan display field 2402 displays a graph regarding prediction of power supply to the facility, the dispatch plan of the dispatched EV, and the like.

The countermeasure planner checks the content of the dispatch plan and the like and presses the operation button 2403. When the operation is received, the countermeasure planning device 100 transmits the dispatch plan to the EV provider. The EV provider checks the transmitted dispatch plan (P1112), and dispatches the EV to the facility based on the dispatch plan (P1113). The countermeasure planner executes feeding using the provided EV (P1114).

When blackout is recovered, the usage flow transitions to the post-recovery phase, the countermeasure planner executes a procedure for returning the EV to the EV provider (P1115), and the EV provider collects the EV (P1116). At this time, the record/settlement management unit 126 of the countermeasure planning device 100 executes a countermeasure record registration process. Specifically, the record/settlement management unit 126 refers to the matching result DB 136 and sets the values to the provision start date 708 and the provision end date 709 to the corresponding entry based on the EV dispatch plan.

The countermeasure planner checks the EV provision record and pays the incentive to the EV provider (P1117), and the EV provider receives the incentive (P1118).

The record/settlement management unit 126 of the countermeasure planning device 100 causes the terminal 102 to display a screen 2500 illustrated in FIG. 25 through the information presentation/acquisition unit 127. The screen 2500 includes a record table 2501 and an operation button 2502. The countermeasure planner refers to the record table 2501, checks the provision record, and presses the operation button 2502 to confirm the payment of the incentive. The record/settlement management unit 126 executes the settlement process along with the operation. Specifically, the record/settlement management unit 126 adds the entry to the settlement DB 139, and sets the values to the matching ID 1001, the payment date 1002, and the incentive 1004 of the entry.

As described above, the countermeasure planning system can select a countermeasure having a high implementation probability while suppressing the cost based on the provision situation of external EV's, the first cost, and the second cost. In the first embodiment, the countermeasure of power supply during the occurrence of a disaster has been described as an example, but the application field is not limited thereto. It is needless to say that the present invention is applicable to a wide range of fields. For example, people, goods, and the like can also be handled as resources.

The present invention is not limited to the embodiment and includes various modification examples. For example, in the embodiments, the configurations have been described in detail in order to easily describe the present invention, and the invention is not necessarily to include all the configurations described above. In addition, addition, deletion, and replacement of another configuration can be made for a part of the configuration in each of the embodiments.

In addition, some or all of the above-described respective configurations, functions, processing units, processing means, and the like may be implemented by hardware, for example, by designing an integrated circuit. In addition, the present invention can also be implemented by program codes of software that implements the functions of the embodiments. In this case, a storage medium that records the program code is provided to a computer, and a processor in the computer reads the program code stored in the storage medium. In this case, the program code itself read from the storage medium implements the functions of the embodiments, and the program code itself and the storage medium recording the program code configure the present invention. As the storage medium for supplying the program code, for example, a flexible disk, a CD-ROM, a DVD-ROM, a hard disk, an SSD (Solid State Drive), or an optical disk, a magneto-optical disk, a CD-R, a magnetic tape, a non-volatile memory card, or a ROM is used.

In addition, the program code implementing the functions described in the embodiments can be implemented in a wide range of programs or script languages such as assembler, C/C++, perl, Shell, PHP, Python, and Java.

Further, the program code of the software implementing the functions of the embodiments may be distributed via a network such that the program code is stored in storage means such as a hard disk or a memory of a computer or in a storage medium such as a CD-RW or a CD-R and a processor in the computer reads and executes the program code stored in the storage means or the storage medium.

In addition, in the embodiments, the drawings illustrate control lines and information lines as considered necessary for descriptions but do not illustrate all control lines or information lines in the products. All the configurations may be interconnected.

The invention claimed is:

1. A computer system that plans a countermeasure relating to disaster recovery in a facility, the computer system comprising:
at least one computer that includes a processor, a storage device connected to the processor, and a network interface connected to the processor,
wherein the storage device stores
cost information for managing a first cost that is an amount of opportunity loss during occurrence of a disaster per facility for which a countermeasure is to be executed and a second cost required for a countermeasure of self-investment, and
provision resource information for managing a resource that is externally provided, and
the processor
refers to the provision resource information to determine whether the resource required for executing a countermeasure utilizing the resource in the designated facility can be ensured, and
selects a countermeasure to be executed on the designated facility based on the first cost, the second cost, and a result of the determination.

2. The computer system according to claim 1,
wherein when the processor determines that the resource required for executing the countermeasure utilizing the resource can be ensured, the processor makes the countermeasure utilizing the resource based on the provision resource information and selects the countermeasure utilizing the resource as the countermeasure to be executed on the designated facility, and
when the resource required for executing the countermeasure utilizing the resource cannot be ensured and the first cost is higher than or equal to the second cost, the processor selects the countermeasure of the self-investment as the countermeasure to be executed on the designated facility.

3. The computer system according to claim 2,
wherein the processor
calculates an upper limit value of a cost of the countermeasure utilizing the resource based on the first cost and the second cost, and
makes the countermeasure utilizing the resource by executing a first matching process of selecting the available resource based on the upper limit value.

4. The computer system according to claim 3,
wherein the processor calculates the upper limit value by multiplying a coefficient acquired from a profit of an operator of the facility by a smaller cost among the first cost and the second cost.

5. The computer system according to claim 2,
wherein the countermeasure is a countermeasure relating to power supply relating to the designated facility, and
the processor
calculates power required for disaster recovery in the designated facility, and
makes the countermeasure of the self-investment based on the calculated power.

6. The computer system according to claim 2,
wherein the processor
receives a request to provide a resource during occurrence of a disaster from the facility for which the countermeasure utilizing the resource is selected,
receives whether the resource is available from a provider that provides the available resource to the facility for which the countermeasure utilizing the resource is selected,
executes a second matching process of selecting the resource to be actually provided to the facility for which the countermeasure utilizing the resource is selected among the resources for which a response that the resource is available is given from the provider, and
makes a plan for providing the resource selected by the second matching process.

7. The computer system according to claim 2,
wherein the processor displays a screen on which the first cost, the second cost, and the selected countermeasure are displayed.

8. A method of planning a countermeasure relating to disaster recovery in a facility that is executed by a computer system,
the computer system
including at least one computer that includes a processor, a storage device connected to the processor, and a network interface connected to the processor, and
managing cost information for managing a first cost that is an amount of opportunity loss during occurrence of a disaster per facility for which a countermeasure is to be executed and a second cost required for a countermeasure of self-investment, and provision resource information for managing a resource that is externally provided, and
the method of planning the countermeasure comprising:
a first step of allowing the at least one computer to refer to the provision resource information to determine whether the resource required for executing a countermeasure utilizing the resource in the designated facility can be ensured, and
a second step of allowing the at least one computer to select a countermeasure to be executed on the designated facility based on the first cost, the second cost, and a result of the determination.

9. The method of planning the countermeasure according to claim 8,
wherein the second step includes a step of allowing the at least one computer to make, when the computer determines that the resource required for executing the countermeasure utilizing the resource can be ensured, the countermeasure utilizing the resource based on the provision resource information and to select the countermeasure utilizing the resource as the countermeasure to be executed on the designated facility, and
a step of allowing the at least one computer to select, when the resource required for executing the countermeasure utilizing the resource cannot be ensured and the first cost is higher than or equal to the second cost, the countermeasure of the self-investment as the countermeasure to be executed on the designated facility.

10. The method of planning the countermeasure according to claim 9, comprising:
a third step of allowing the at least one computer to calculate an upper limit value of a cost of the countermeasure utilizing the resource based on the first cost and the second cost; and
a fourth step of allowing the at least one computer to make the countermeasure utilizing the resource by executing a first matching process of selecting the available resource based on the upper limit value.

11. The method of planning the countermeasure according to claim 10,
wherein the third step includes a step of allowing the at least one computer to calculate the upper limit value by multiplying a coefficient acquired from a profit of an operator of the facility by a smaller cost among the first cost and the second cost.

12. The method of planning the countermeasure according to claim 9,
wherein the countermeasure is a countermeasure relating to power supply of the designated facility, and
the method of planning the countermeasure comprises
a step of allowing the at least one computer to calculate power required for disaster recovery in the designated facility, and
a step of allowing the at least one computer to make the countermeasure of the self-investment based on the calculated power.

13. The method of planning the countermeasure according to claim 9, further comprising:
a step of allowing the at least one computer to receive a request to provide a resource during occurrence of a disaster from the facility for which the countermeasure utilizing the resource is selected;
a step of allowing the at least one computer to receive whether the resource is available from a provider that provides the available resource to the facility for which the countermeasure utilizing the resource is selected;
a step of allowing the at least one computer to execute a second matching process of selecting the resource to be actually provided to the facility for which the countermeasure utilizing the resource is selected among the resources for which a response that the resource is available is given from the provider; and
a step of allowing the at least one computer to make a plan for providing the resource selected by the second matching process.

14. The method of planning the countermeasure according to claim 9, further comprising:
a step of allowing the at least one computer to display a screen on which the first cost, the second cost, and the selected countermeasure are displayed.
